(19) United States
(12) Patent Application Publication
(10) Pub. No.: US 2015/0032718 A1
(43) Pub. Date: Jan. 29, 2015

(54) METHOD AND SYSTEM FOR SEARCHES IN DIGITAL CONTENT

(71) Applicant: VIDISPINE AB, Kista (SE)

(72) Inventors: Erik Åhlin, Sollentuna (SE); Isak Jonsson, Uppsala (SE)

(73) Assignee: VIDISPINE AB, Kista (SE)

(21) Appl. No.: 14/512,146

(22) Filed: Oct. 10, 2014

Related U.S. Application Data
(63) Continuation of application No. PCT/SE2013/050385, filed on Apr. 10, 2013.
(60) Provisional application No. 61/622,722, filed on Apr. 11, 2012.

(30) Foreign Application Priority Data
Apr. 11, 2012 (SE) 1250360-3
Jul. 6, 2012 (SE) 1250794

(51) Int. Cl. G06F 17/30

(52) U.S. Cl. CPC G06F 17/30061; G06F 17/30867
USPC 707/710

(57) ABSTRACT

A method for supporting searching in digital multimedia content comprising forming a virtual solid body by calculation of a primary area and a secondary area, separated by a function of time, wherein the calculation forms the virtual solid body, associating a metadata object with the virtual solid body, creating a record for the virtual solid body, the record containing the metadata object associated with the virtual solid body, providing the record to a search engine, wherein the record is arranged such that searches can be performed by the search engine, potentially resulting in a pointer to the virtual solid body in the content.

### TECHNICAL FIELD

Present invention relates to a method for searches in digital content. The invention also relates to a system for searches in digital content. The invention also relates to a computer program product for searches in digital content.

### BACKGROUND

The media landscape of today changes to a more complex nature than historically. The number of media production companies might increase, however their capture and generation of multimedia content significantly increases. Further, new devices like mobile terminals and other electronic devices capture and generate significant quantities of digital content. Prior to the digitalization of devices for consumer usage, such as digital cameras, video cameras, mobile phones, and similar electronic devices, hardly any user generated content, was published or made available to the public.

Most multimedia content of today is in digital format. Even historical content of interest is being digitalized. TV broadcasting companies and other media companies typically store content in electronic archives. The content may be intended for later publication or normal archiving.

A broadcast from, for example a sports game or a news spot, is typically built of a number of clips. Typically the clips are built of a number scenes, such as a plurality of camera shots, a number of sound tracks, or/and post process added material. For example, a clip may exceed over a hundred channels. Even a single radio news spot may include a large number of elements of content.

The basic idea with an archive is obviously to be able to find historical news, entertainment, or similar material, regardless of if it has been published or not. The finer granularity, i.e. more related information, the better chance to find relevant material. Although one challenge with finer granularity is the potential greater number of hits, at archive searches.

Content generated for sole commercial usage, for example commercials, has in principal the same needs as, for example news or entertainment material in relation to archives. But material intended for commercial usage, is sometimes planned for usage over a time period covering multi cultural and multilingual audiences, which requires flexibility in terms of content management. Yet another dimension of complexity is where non-commercial content is mixed with commercial content, or non-commercial content is mixed with different commercial content, where the different commercial content is intended for different target groups. An example may be sports event of a regional or global interest, but which includes local commercial messages and/or user generated content in local languages.

The archive solutions for digital multimedia content of today are typically created with a predefined structure, e.g. a fixed database structure for storage of content and a fixed database structure for storage of metadata. The metadata is important to be able to find content in an archive. The better metadata the higher value of a content archive. Predetermined structures for metadata allow users to automatically or manually enter data such as a location, character person in a scene, or a contextual description. There are today different systems for metadata, some are generic and some are intended for a specific kind of content such as news, sports, commercials, etc.

There are a number of problems with the technical solutions of today. For each cut of a video, a specific metadata model has to be determined. There are today no systems that can manage an infinite number of metadata models per repository and individual assets, e.g. data storage structure. Today's metadata models are, for example, either static on a per cut basis, or limited to a number pre specified number levels or steps in a hierarchy. An example is shown in FIG. 1, as an example a movie clip, with two type's metadata describing the movie. Yet another problem with today's technologies is management of different types of content, i.e. the subcomponents of content. It is not possible to do generic handling of different types of subcomponents like sound tracks, video tracks, graphics, subtitles, captions, voice owners, etc. Instead each subcomponent needs to be pre defined and it needs it own structure.

The above described limitations and other limitations, prevents growths of and quality of metadata. That in turn leads to limitation of the value of the metadata. It becomes difficult to find archived content, and traceability becomes limited. New technologies for media capture, for example cameras, will in the future generate an increasing amount of metadata. Another factor that will drive the increase of metadata is the editing process, where metadata is added to content in a stage after a capture. Another example of a problem today is that users of a search system will either not find content searched for, or receive too many hits in a search. Too many hits will require a long time to analyze, and an increasing risk of missing interesting content or content searched for.

The limitations of existing technologies for searches of digital multimedia content, will become larger in the future with larger amounts of content as well as larger amounts metadata, and further varied content types and types of generated metadata.

### SUMMARY

It is an object of the invention to address at least some of the problems and issues outlined above. It is possible to achieve these objects and others by using a method and a system as defined in the attached independent claims.

According to an aspect, a method is provided for supporting searches in digital multimedia content. The method comprises forming a virtual solid body by calculation of a primary area and a secondary area, separated by a function of time, wherein the calculation forms the virtual solid body, association of a metadata object with the virtual solid body, creation of a record for the virtual solid body, where the record contains the metadata object associated with the virtual solid body, and providing the record to a search engine, wherein the record is arranged such that searches can be performed by the search engine, potentially resulting in a pointer to the virtual solid body in the content.

An advantage with the method is to find objects like a face, person or a commercial product in digital multimedia content.

According to another aspect, a system is provided for supporting searches in digital multimedia content. The system comprises means for forming of a virtual solid body by calculation of a primary area and a secondary area, separated by a function of time, wherein the calculation forms the virtual solid body, means for association of a metadata object with the virtual solid body, means for creation of a record for the virtual solid body, the record containing the metadata object associated with the virtual solid body, and means for provision of the record to a search engine, wherein the record is arranged such that searches can be performed by the search engine, potentially resulting in a pointer to the virtual solid body in the content.

An advantage with the system is to support searches in databases for shown over a time period, or a sequence of video frames in digital multimedia content, and returning a handle for further preparation for example modifying the video according to rules based on metadata or automatically create new versions based on metadata triggers.

The above method and system may be configured and implemented according to different optional embodiments. In one possible embodiment of the solution, it may include the steps of reception of a first video frame with the primary area and a second video frame with the secondary area, where the primary area and secondary area are associated with each other, and reception of at least one metadata object associated with at least one of the areas. In an embodiment is the virtual solid body calculated by use of parametric curves or NURBS. In an embodiment is the virtual solid body is approximated to a rectangular shaped form. In an embodiment is a video frame a three dimensional projection of a scene. In an embodiment is a virtual solid body is defined by a time interval determined by the first video frame and the second video frame. In an embodiment contains the first video frame a plurality of primary areas and or secondary areas.

In an embodiment forms the plurality of primary areas and/or secondary areas a plurality of virtual solid bodies, wherein the virtual solid bodies are at least partially overlapping each other. In an embodiment one virtual solid body at least partially encapsulate another virtual solid body. In an embodiment is a relation between two virtual solid bodies determined by calculation of a distance between a first virtual solid body and a second virtual solid body, when the bodies extends through a video frame, wherein the video frame is represented by a coordinate system, and thus is the distance between the bodies calculable by each body being associated with respective coordinates. In an embodiment the solution may include the step of storage of the video frame in a first database. In an embodiment the solution may include the step of storage of the metadata object in a second database. In an embodiment the solution may include the step of association of at least one metadata object, independently, with another metadata object.

An advantage is to find relations between objects through searches, or support searches for related objects. Another advantage is to support searches related to specific objects in digital multimedia content.

In an embodiment is a computer program, comprising computer readable code means provided, which when run in a system for searches in digital multimedia content causes the system for searches in digital multimedia content to perform the corresponding steps. In an embodiment is a computer program product provided, comprising a computer readable medium and a computer program according to the described solution, wherein the computer program is stored on the computer readable medium.

Further possible features and benefits of this solution will become apparent from the detailed description below.

### BRIEF DESCRIPTION OF THE DRAWINGS

Method steps and units appearing in multiple figures have the same references in the different figures.

The invention will now be described in more detail by means of exemplary embodiments and with reference to the accompanying drawings, in which:

FIG. 1 shows a data structure according to prior art.

FIG. 2 shows an overview of elements in a system.

FIG. 3a shows a flowchart for content search.

FIG. 3b shows a flowchart of an embodiment for content search.

FIG. 4 is a schematic view of content and metadata object.

FIG. 5 is a schematic view of an embodiment of content and metadata object.

FIG. 6 is a block diagram illustrating units in a system for content search.

FIG. 7 shows a virtual solid body and related elements.

FIG. 8 illustrates an embodiment of relations between virtual solid bodies.

FIG. 9 shows a flowchart for searches in digital content.

FIG. 10 shows a flowchart of embodiments for searches in digital content.

### DESCRIPTION

Present solution relates to a method and a system for searches in digital content, in particular a broad scope of multimedia content, including but not limited to video, pictures, graphics, voice, music, general sound, and similar formats. When performing searches for information in text documents, there are today methods and tools for effective search. One reason for that is the fact that text documents are easily readable by a machine. However, when a content is not directly readable by a machine, search ability becomes dependent on metadata. If one makes the comparison with the old photo archive with old days news papers, the archive was totally dependent on how well it was structured and how well the photos where described. With present terminology this could be expressed as metadata and structures thereof. This applies to also today's archives for digital multimedia content.

It is an objective of the present solution to enable searches of content and metadata, and as results receive relevant content. And only relevant content searched for.

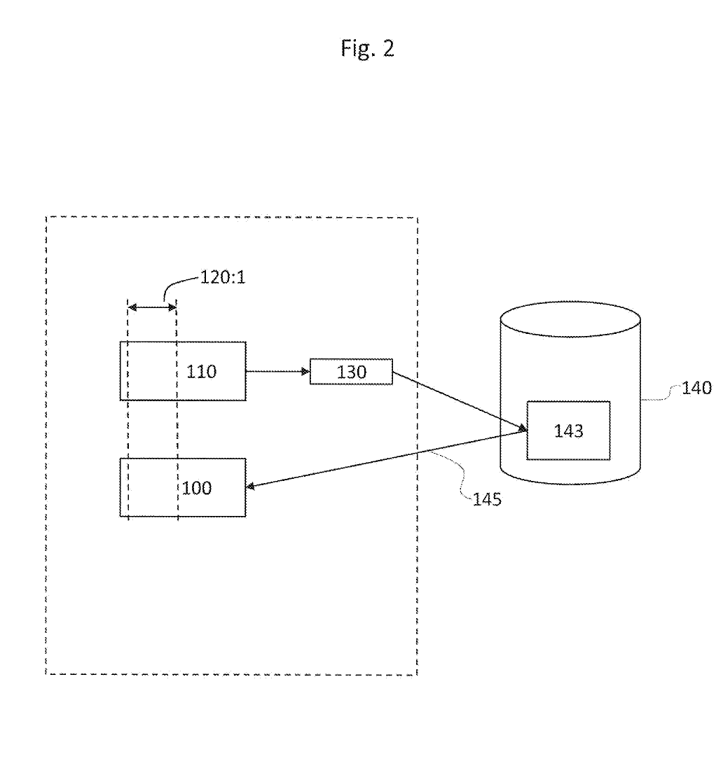

FIG. 2 shows and overview of some elements in an embodiment of a method, system and a computer program for searches in digital multimedia content 100. The figure also shows a metadata object 110. Further is a time interval 120 with a start and stop shown, followed by a record 130 and a search engine 140, with an index 143 and a pointer 145.

Digital multimedia content 100 is hereinafter referred to as content 100, and content 100 may in a broad scope include any general content in digital format. Examples of such content are: movies, multimedia, sounds, graphics, texts, not limiting content to other types of content. A description of metadata is information about information. Some information about a video or a photo may facilitate to find, for example, a desired video or a part of a video. According to the figure, a content 100 is associated with a metadata object 110 through a time interval 120. Of the metadata object 110 associated with the time interval 120 of the content 100, a record 130 is created. A record 130 is advantageous for a search engine 140, performing searches. As an example a record 130 may be used for generation of an index, such as the index 143 shown in FIG. 2. When the search engine 140 performs a search, a result may be generated as pointer to a content 100. The pointer indicating a content 100, or a part of content 100 that coincidences with a metadata object 110, descriptive for the content 100.

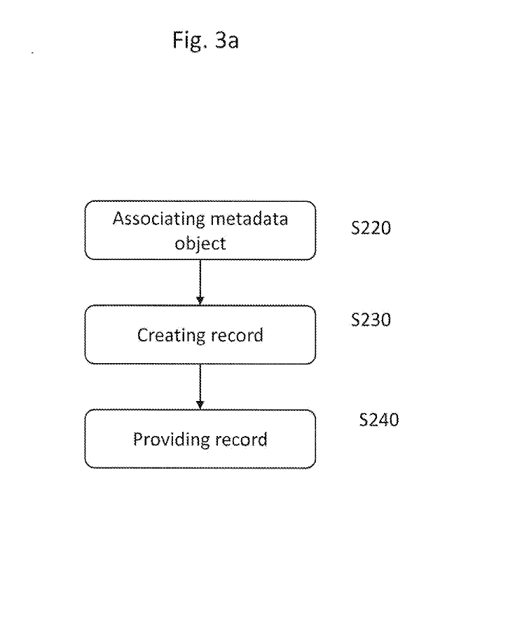

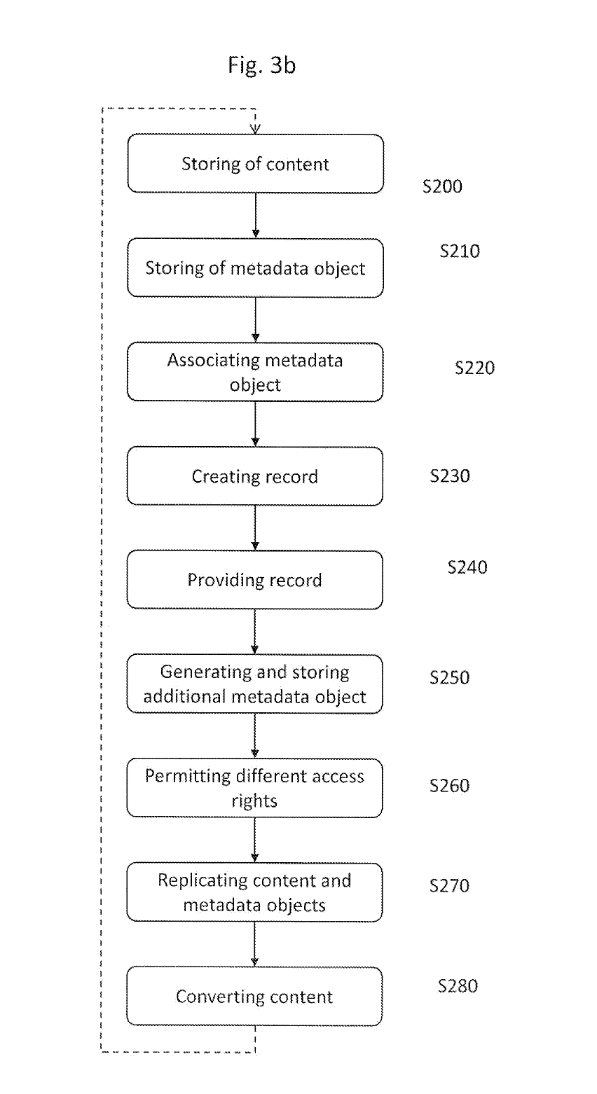

FIG. 3a shows a flowchart illustrating an embodiment of a method for searching multimedia content 100.

According to FIG. 3a the first step S220 in the flowchart, the method comprises associating a metadata object 110 with a respectively time interval 120 of a content 100. A content 100 may be any type of digital content. According to an embodiment content 100 may be at least one, or a plurality of pictures, video, still or moving graphics, different kind of sounds like voice, music, effects, overdubs, or documents such as plain text or rich text formats. A metadata object 110 may refer to another metadata object 110. A metadata object 110 may also be a descriptive information. Such descriptive information may include a specification and the information itself. An example is specification: “title” with the information “Playing kids”. Other examples may include: location and other geographical information, participants, production ids, camera angles, weather conditions, scenes, authors, date, types codecs, type, id, remark, relationship, type of relationship, flags, class, status. These examples are not limiting other types of metadata. According to an embodiment, a time interval 120 is a time period with a defined start time and a stop time. The start and stop time may, for example, be an absolute time, or a time relative to the start of the duration of the digital content, represented in seconds or samples.

A defined start time and stop time, is advantageous for facilitation of an association between a content 100 and a metadata object 110. The time interval 120 advantageously defines the part of a content 100, which the metadata object 110 relates to.

The method further in step S230 comprises creating a record 130 for a time interval 120. According to an embodiment, the record 130 contains at least one metadata object 110. The record 130 relates to a specific content 100. The record 130 may be in different formats. In an embodiment the record 130 may be in xml-format. Other examples of formats are: plain text, html, pdf, ascii rich text formats, or spreadsheet formats.

In step S240 the method comprises providing the record 130 to a search engine 140. In an embodiment the record 130 is arranged such that searches can be performed by a search engine 140, and potentially resulting in at least one pointer 145, to at least one time interval 120 of a content 100. How a search engine works in detail is not described herein, because it is not in the scope of the invention. However the record 130 may for example be used as for generation of an index 143.

A record 130 is advantageous for a search engine 140, and for generation of an index 143. Thereby the search engine becomes independent of any metadata structure, an unlimited to size and classification of metadata.

FIG. 3b shows a flowchart of another embodiment of method for searching multimedia content 100. The method according to FIG. 3b may include the steps shown in FIG. 3a.

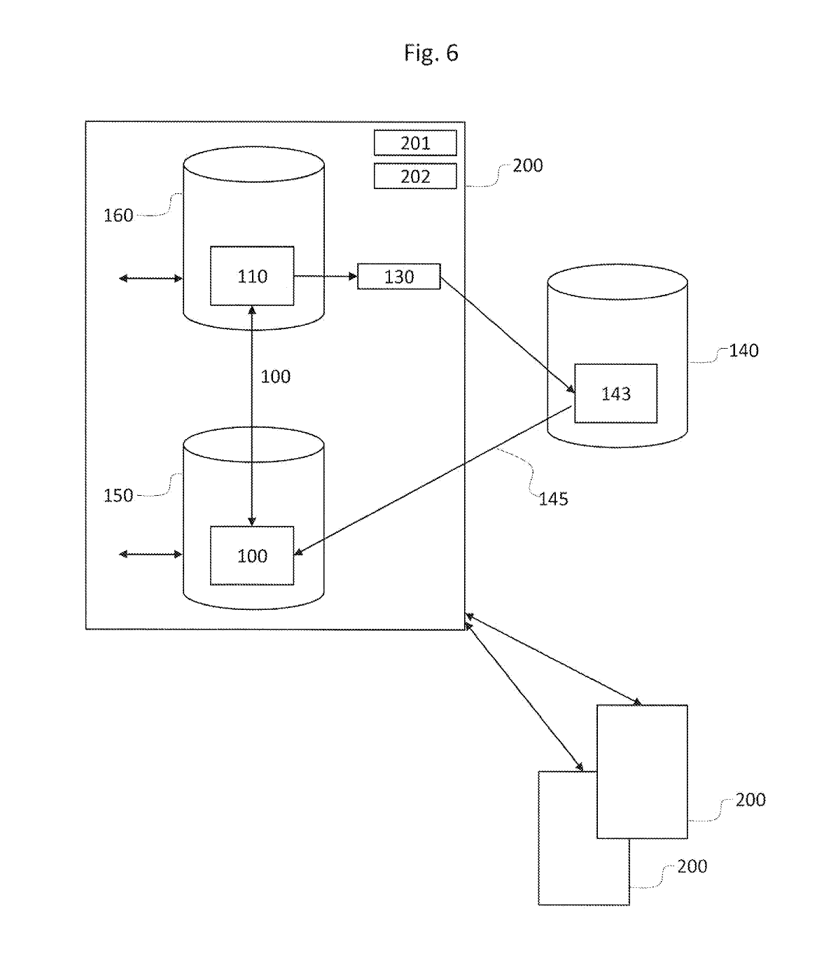

Step S200 comprises storing of content 100. Storage of content is further described in FIG. 6. The content 100 may be received from a camera, microphone, or other capturing device. The content 100 may as well, for example, be post processed or recorded for archive purposes. Before storing of content 100, it may be converted from one format to another format not shown in the figure

Step S210 comprises storing of metadata object 110. Metadata object 110 may be received in parallel with content 100, or received separately. Metadata 110 may be received in principal simultaneously with content 100, or at another occasion.

Step S220 to step S240 is in principal identical with the steps shown in FIG. 3a.

Step S250 comprises generating and storing of additional metadata object or objects 110. In an embodiment it is possible to further add metadata object or objects 110. Such metadata objects 110 may include information added by manual entry of information by an operator. Such metadata objects 110 may also be entered by a machine. Metadata objects 110 may be captured from content 100 through analysis.

Step S260 comprises permitting different access rights. Different access rights may provide different users of a method for searching multimedia content 100, limited access to content 100, or selective access to content 100. Such an access right my for example be determined by the type of content 100, the type of metadata 110, by whom content 100 or metadata 110 is originating from. Or from which machine or automatic process content 100 or metadata 110 is originating.

Differentiated access right is advantageous for enablement of permission to content to users with different roles. Different roles may be people with different work tasks. Different roles may also be different organizations, such is different companies or different audiences.

Step S270 comprises replicating content 100 and/or metadata object 110. A small installation of a system performing the steps in a method for searching multimedia content 100, may only include a single physical unit. A larger installation may include a plurality of physical unit located together. Optionally the method is carried out on units distributed throughout a network. With the units physically distanced. Some units may be always connected to a network, and some units may be both online as well as offline.

Step S280 comprises converting content 100. In an embodiment content 100 may be converted from one format to another format when retrieved from a database further described in FIG. 6. If for example content 100 is stored in an original format, it may be suitable to convert content 100 to a format that may be adapted for a editing device, distribution format, play out device or similar. An example may be conversion of a high definition format media to a media adapted for a mobile device.

The steps described in FIG. 3b, may be performed in different orders, than shown in the figure, according to various embodiments. Further may some of the steps be omitted, which may depend on preferred usage of the solution.

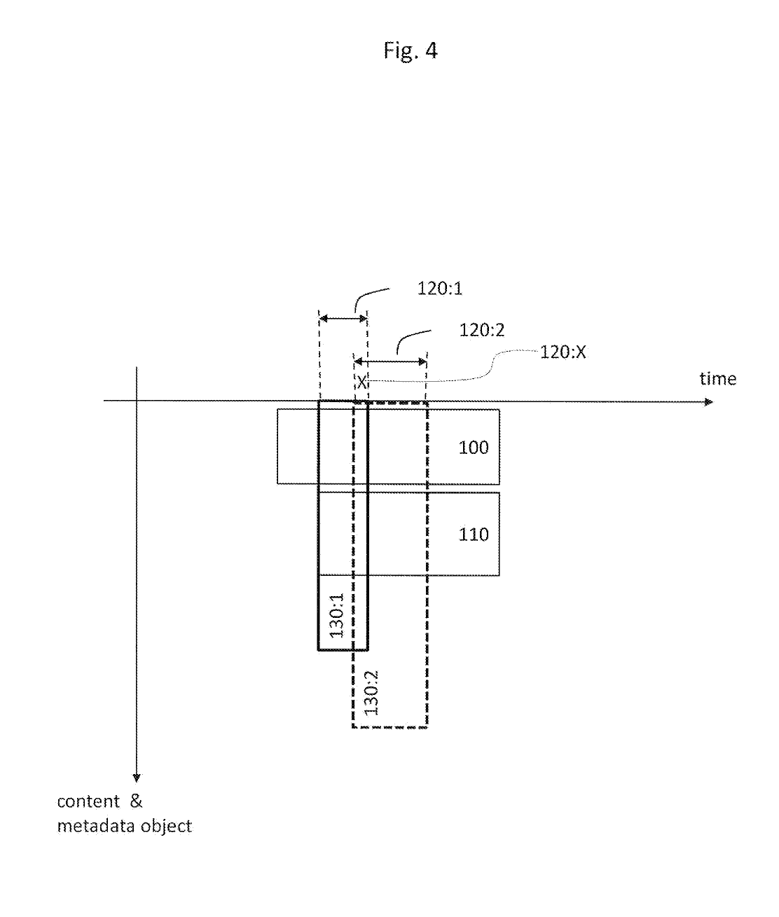

In FIG. 4 content 100 and metadata 110 is shown. Additionally an axis representing time and an axis representing content 100 and metadata 110.

According to FIG. 4, a content 100 extends along the time axis. Further a metadata object 110 extends along the time axis. The metadata object 110 start time point and stop time point may coincidence with the content 100, but the metadata object 110 may as well have a different start and stop time points relative to content 100. The content 100 and the metadata object 110 are associated with a time interval 120, according to FIG. 4. The time interval 120 is defined by a start point and a stop point. In an embodiment, not shown in the figure, the time interval 120 is infinite. A time interval 120 may be infinite when a content 100 is exemplified by a picture, a graphical picture, a generic file, or other non motional digital content 100. An example is, in a case where the start and stop time is undetermined. As shown in the figure, a record 130 is determined by the time interval 120. The record 130 contain at least one metadata object 110 associated with the content 100.

In an embodiment not shown in the figure, another record 130 may be determined by a different time interval 120 than the first mentioned record 130. E.g. a plurality of records 130 does not have to come in line as a chain, with a subsequent record 130 start where a previous record 130 stops.

However as shown in FIG. 4, a record 130:1 may be determined by a first time interval 120:1 and another record 130:2 may be determined by a second time interval 120:2. The second time interval 120:2 may overlap the first mentioned time interval 120:1. An effect of such overlap is that each record 130, defined by each time interval 120, will contain at least one metadata object 110, associated with the metadata objects 110 respective content 100. The overlap formed by the both records, may collectively point to a time interval 120:X of content 100 only covered by the both records 130:1 and 130:2.

Two or more metadata objects 110 that overlap each other is advantageous, because in may enable a user to find content 100 that is only related to the at least both metadata objects 110.

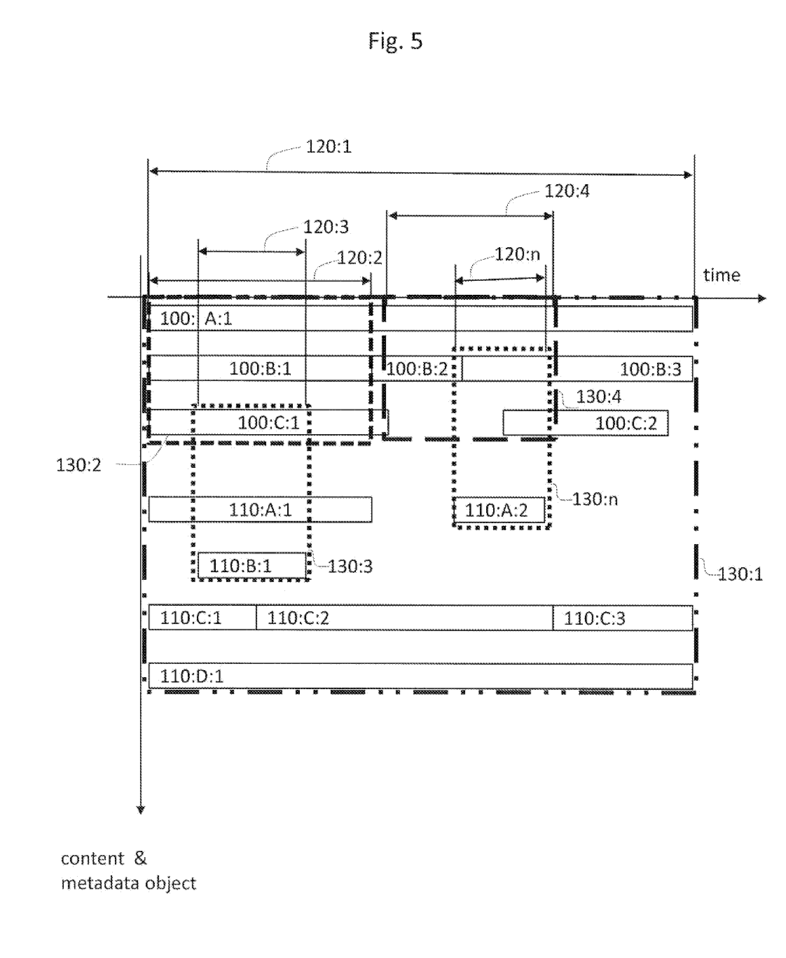

FIG. 5 shows an embodiment of contents 100 and metadata objects 110 that extend along a time axis and are distributed along the other axis. This figure shows pluralities of content 100, metadata 110, time intervals 120, and records 130.

FIG. 5 shows a plurality of content 100 100:A, 100:B, 100:C, and so on. Various elements of content 100 that form, for example, a complete digital multimedia content 100, such as a complete movie, may also be referred to as components, or tracks. Each component may comprise various video, sound, graphics, subtitles, name of speaker voice, animations, etc. A component of content 100 may extend through an entire duration of a content 100, exemplified by content 100:A:1. Content 100 may also be formed by a number of components in a series, shown as content 100:B:1, content 100:B:2, and content 100:B:3. Another example is content 100 formed by components of content 100:C1 and 100:C:2. In yet another example, as shown in FIG. 5, a number of tracks of components of content 100:A:1-100:C:2 collectively form content 100. An example is a news spot, with a number of video elements from a studio and various different scenes, accompanied by voices, sounds, recordings, music, graphics, and other related content. Another example is a broadcast of a football game, where a number of cameras may record the game from different views and angels, accompanied with sound recordings from microphones, speaker voices, commentator voices, graphics, and other multimedia related to the game. Other example may be a list or a log from movie production with multiple revisions and version including metadata around decisions, cuts, dialogues, scripts, rights, etc.

According to FIG. 5 metadata object 110 is structured in a similar manner as content 100. A metadata object 110 may extend along the time axis. Metadata object 110 may have an in principal direct relation with a content 100, for example a camera position, angle, or a capture time and date. An example of such direct related metadata objects 110 are metadata object 110:A:1 and 110:A:2. Another example of a metadata object 110, may be main character, or a specific environment, appearing in a certain time interval 120 of a content 100. An example, according to FIG. 5, metadata object 110:B:1 is determined by the time interval 120:3 and associated with the content 100:C:1. Yet another example of metadata object 110 is a metadata object 110 that extends along with a full time interval 120 of a content 100. An example is a same type of metadata object 110:C:1, 110:C:2, 110:C:3, such as the name of respective studio person 1, 2 and 3 throughout a news spot. Yet another example of a metadata object 110, is a metadata object 110:D:1 which, according to the figure extends along with an entire time interval 120 of a content 100. An example of a metadata object 110:D:1 may be a title, a description, author, free text information, comments, GPS coordinates, quality check information or other information relevant to an content 100 not partial limited by a time interval 120.

Metadata objects 110 that may be defined unlimited of any predefined structure is advantageous because it permits entry of new meta data types, potentially not originally thought of. Further metadata objects 110 according to the above described structure, is advantageous because permit associations unlimited to any pre determined structure. It allows for multiple, disparate and individually unrelated structures on the same content and asset.

FIG. 6 shows a view of a system comprising a first database 150 for storage of content 100, a second database 160 for storage of metadata objects 110. The first and second databases 150, 160 arranged in a node. The node 200 also including a processing unit 201 and a memory unit 202. A search engine 140 that can use an index 143, is also shown in the figure.

According to FIG. 6 the first database 150 has an interface for reception of content 100 and retrieval of content 100. The first database 150 also has an interface for communication with the second database 160. Associations between content 100 and metadata 110 may be performed over the interface between the first and second database 150, 160. At storage of content 100 a conversion may be performed from one format to another format of content 100. Conversion may also be performed at retrieval of content 100 from the first database 150, conversion from one format to another format. Although the first database 150 may handle various formats of content 100, and is therefore not bound by any specified formats.

In FIG. 6 is further the second database 160 for metadata object 110 storage, shown. The second database 160 has an interface for reception and retrieval of metadata objects 110. That interface may receive metadata objects 110 generated by machine, or entered by an operator. Metadata objects 110 may be received and stored in the second database 160 unlimited subsequently. The interfaces on the databases, for reception and retrieval, may also be suitable for other systems that perform post analysis of content 100 or metadata objects 110. Example of such systems for post processing may be face recognition, voice recognition, technical quality data, rights management, automatic trimming, any kind of rules based automatic editing, etc.

As shown in FIG. 6, the record 130 is created in the second database 160. The record 130 is either transmitted to a search engine 140, or retrieved by the search engine 140. The search engine 140 itself is outside the scope of this solution. However typically a search engine 140 uses a record 130 for generation of an index 143. And in this solution an index 143 may be used by a search engine 140, for generation of potentially at least one pointer to a content 100, in the first database 150. That may be the case when a search in digital multimedia content is performed, by use of a single, or a plurality of search terms, collectively or combined in a certain way. Such a search may match with metadata objects 110 associated with time intervals 120 of content 100, and thereby provide a desired search result.

FIG. 6 shows a couple of additional nodes 200. In a large system solution, a plurality of nodes 200 may serve users with the same or similar functionality, as a single node. It may as well be the case that different nodes 200 may contain different functionality and therefore carry out different functionalities, or partially different functionalities. How to architect and set up computers and communications networks for a solution, is known to the person skilled in the art. It is therefore understood that there are a number of variants of how to set up a system, not limited by above described examples.

Replication may be advantageous in a large scale system. Replication also may be advantageous in a distributed system where users are located over distances. Replication may also be advantageous when users may be partly off-line and partly on-line, and thereby having access to content even when off-line.

In an embodiment, the node 200 comprises a processing unit 201 for execution of instructions of computer program software, according to FIG. 6. The figure further shows a memory unit 202 for storage of a computer program software and cooperation with the processing unit 201. Such processing unit 201 and memory unit 202 may be provided by a general purpose computer, or a computer dedicated for multimedia content searches.

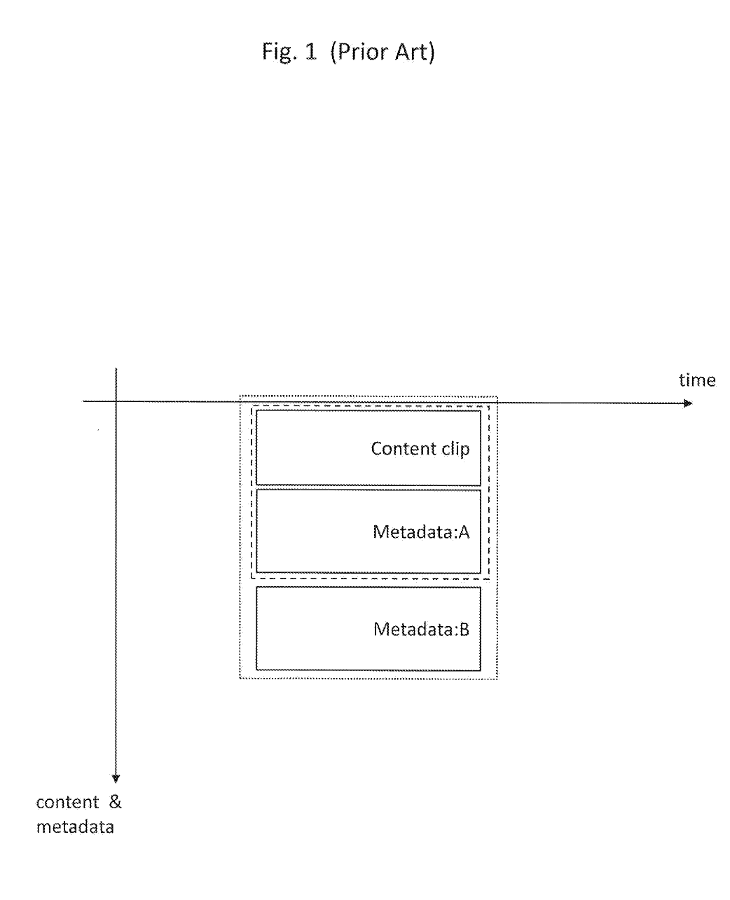

In an embodiment, not shown in figures, content 100 may be user generated content. Such content may not technically be different from other content. The difference may rather be seen from a scale and device perspective. As an example public TV, buys a production from a production company showing a football event, and broadcasts it to its TV audience. However the live watching audience on an arena, may use their electronic devices, for captures of the game. An audience may range from a few people watching the local school game, to a major event with tens of thousands of people present. A few examples of electric devices used, may be mobile phones, pda's, video cameras, and similar. user generated content may be stored as content 100 in a first database 150, and metadata object 110 may be stored in a second database 160. And thereafter be treated in similar way as above described content 100 and metadata object 110 according to FIGS. 1 to 5.

It should be noted that FIG. 6 illustrates various functional units in the node 200 and the skilled person is able to implement these functional units in practice using suitable software and hardware means. Thus, this aspect of the solution is generally not limited to the shown structures of node 200, and the databases 150, 160 may be configured to operate according to any of the features described in this disclosure, where appropriate.

In an embodiment, a metadata object 110 may be stored in the second database 160 in different formats.

An illustrating “example 1” of a format of storage of metadata, such as a metadata object 110, is storage of metadata field values as records, where they may be stored as individual values, including start and stop time, or grouped together, where time segments with common metadata is stored, or a combination thereof.

### Example

Field F1, value=X from T1 to T2.
Field F2, value=Y from T1 to T2.
Field F3, value=Z from T1 to T3, value=U from T3 to T4, value=Z from T4 to T2.

### T1<T3<T4<T2

### Example of Record Structure (all Values Stored Individually):

### T1-T2:{(F1,X)}

### T1-T2:{(F2,Y)}

### T1-T3:{(F3,Z)}

### T3-T4:{(F3,U)}

### T4-T2:{(F3,Z)}

This structure may be advantageous from a storage perspective. However, it may not always be well suited for AND-clauses: “find material where F1=X and F3=Z”. This may generate several records back from the search engine, and the intersection then has to be calculated.

In an embodiment, illustrating an “example 2” of storage of metadata, is where segments with similar metadata is stored together (store segments with similar metadata):

### T1-T3:{(F1,X),(F2,Y),(F3,Z)}

### T3-T4:{(F1,X),(F2,Y),(F3,U)}

### T4-T2:{(F1,X),(F2,Y),(F3,Z)}

This storage structure may be advantageous for a question such as “find material where F1=X and F3=Z”, as it may return directly the two intervals T1-T3 and T4-T2. However, if the search clause is “find material where F1=X”, several records may be returned and has to be combined/simplified, to give the correct answer T1-T2. Hence, a metadata field with a lot of different values (here, F3), may degrade performance.

In an embodiment, illustrating an “example 3” a combination of the above two embodiment may be used, as a kind of hybrid. A non-limiting example:

### T1-T2:{(F1,X),(F2,Y)

### T1-T3:{(F3,Z)}

### T3-T4:{(F3,U)}

### T4-T2:{(F3,Z)}

This model may be advantageous for searching combinations such as for example “F1=X and F2=Y”. In an embodiment a statistical model based on the data distribution of the actual values and the search patterns from the users, may be used. For example, if F3 is seldom used in searching, and has a lot of values/intervals, it may be stored separately, like “example 3”. With this model, it may be possible to dynamically redistribute data when it may appear probable that it would give a better performance of searches or data handling.

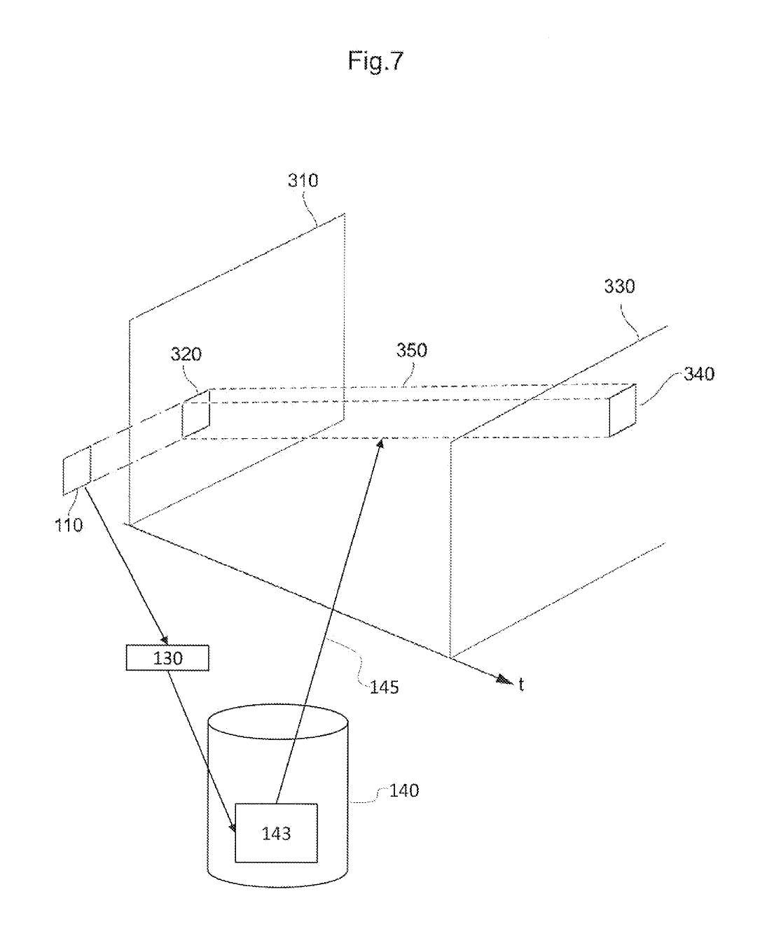

FIG. 7 shows a first video frame 310 and a second video frame 330, with a primary area 320 and secondary area 340.

A first video frame 310 is received, to a system for searches in digital multimedia content 100, and has a primary area 320 as a part of the first video frame 310. The primary area 320 may for example be; a mathematically defined area, a graphical shape or objects like a window on a house or a face of a human being, a brand, a consumer product, or an artefact. Further is a second video frame 330 received.

The second video frame 330 has a secondary area 340. The secondary area 340 is associated with the primary area 320. The secondary area 340 may have an identically shaped area as the primary area 320. The secondary area 340 may have a similar shaped area as the primary area 320. However, the secondary area 340 may have a shape different than the primary area 320. At least one metadata object 110 is received, which is associated with one of the received areas 320; 340. In an embodiment, a metadata object 110 is received, and the metadata object 110 may be associated with each area 320 or 340. Based on the primary area 320 and the secondary area 340, a virtual solid body 350 is formed. The virtual solid body 350 is calculated as a function of time, and shaped of the primary area 320 and the secondary area 340. I.e. the virtual solid body 350 is formed by the primary area 320 and the secondary area 340 separated by a function of time.

Next is the at least one metadata object 110 associated with the virtual solid body 350. A record 130 is created for the virtual solid body 350. And the record 130 contains the at least one metadata object 110. The record 130 is provided to a search engine 140. At the search engine 140, the record 130 is arranged such that searches can be done, potentially resulting in a pointer to a virtual solid body 350, in the content 100.

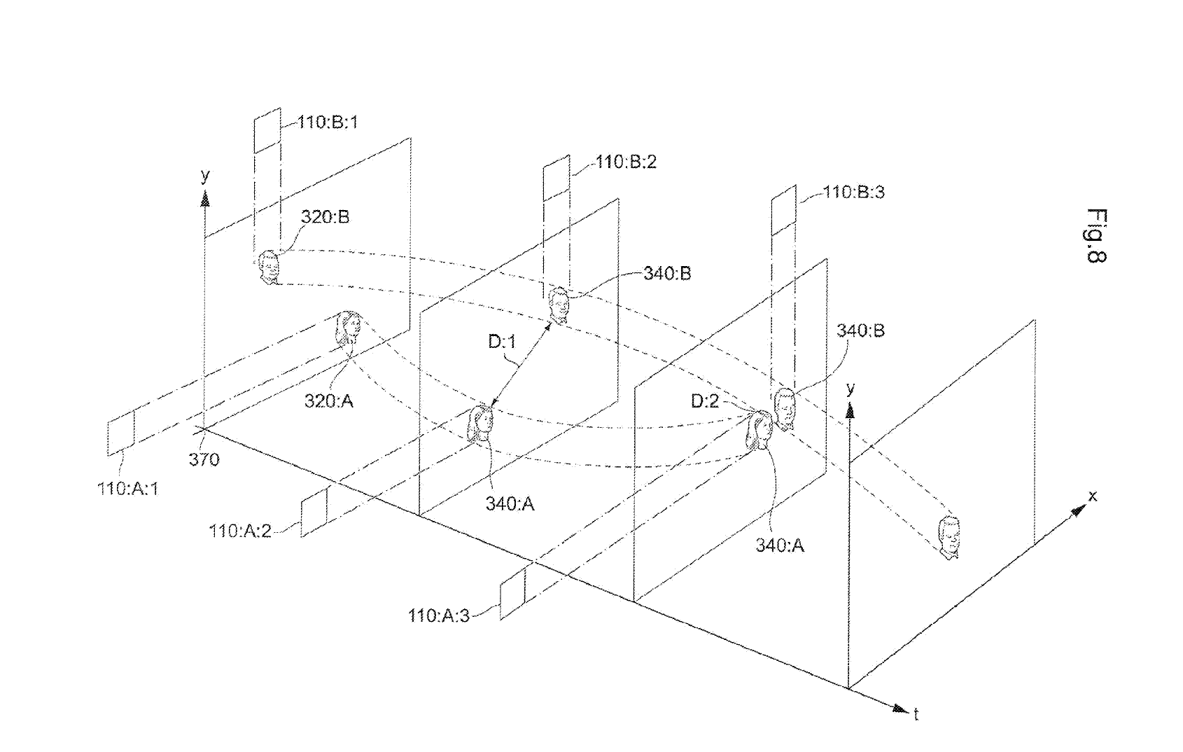

FIG. 8 shows illustrative embodiments of a system for searches in content 100. A first video frame 310 received to the system may contain a plurality of primary areas 320. For example, primary areas 320 may be a football player and a football, or a group of players fighting for the ball. Primary areas 320 may also be faces, or a few central characters, or one or several static objects. A static object may be a decor, or a certain item, e.g. a commercial product with a certain brand or shape, the brand itself, an artefact like a vase, car, apple, or any other. A received first video frame 310, with a primary area 320, may be followed by one or a plurality of subsequent second video frames 330, including the secondary areas 340. A virtual solid body 350 may be formed between the primary area 320 and the secondary area 340. The primary area 320 and secondary area 340, or secondary areas 340, are separated by time. The virtual solid body 350 is formed by calculation of the primary area 320 and the secondary area 340 separated by a function of time. The calculation may also include a determination of the primary area 320 and/or secondary area 340, and shaping the virtual solid body 350 according to the determined areas and calculation the virtual solid body 350 as a function of time. The virtual solid body 350 may also be termed, volume, virtual volume, digital volume, body, digital body, or other suitable terms for multimedia areas a function of time.

According to an embodiment the virtual solid body 350 may be calculated by use of parametric curves. The virtual solid body 350 may be calculated by use of NURBS (Non-uniform rational basis spline). The virtual solid body 350 may also be calculated according to other suitable methods, for calculation of a virtual solid body 350 starting with a primary area 320, and extending through a number of subsequent secondary areas 340, separated by time. The virtual solid body 350 may be approximated to a rectangular shaped form. I.e. even if an area has the form of a face, human body, or a bicycle, it may be given a approximately shape as a rectangular form. An advantage with such arrangement, is less required database capacity and computing power.

In an embodiment a video frame may be a three dimensional image, created by two pictures overlaid, or provided by a plurality of cameras creating the 3D-image. A virtual solid body 350 formed by 3D-frames may substantially be created the same way, as the virtual solid body 350 formed by two dimensional frames. In an embodiment a video frame may have a time stamp, and each individual subsequent video frame may have its individual time stamp. By determination of the time stamp of the first video frame 310 and the last subsequent second video frame 330, it may be possible to provide the virtual solid body 350 with a start time stamp and a stop time stamp and/or a time interval.

A first video frame 310 may contain a plurality of primary areas 320. In a series of subsequent video frames in by example a video clip, a commercial ad, or a full length movie, a video frame may contain both one or a plurality of primary areas 320 as well as one or a plurality of secondary areas 340. An example is a football game with a number of players moving in and out of a camera view, or a home cinema movie with a number of characters, objects, and other sceneries passes by through the movie. Each person or object may for each continues presence in a sequence of video frames, be formed as virtual solid body 350 through the sequence of video frames.

As a consequence of the above, virtual solid bodies 350 may be overlapping. For example, a first character enters a scene followed by a second character enter the scene, than leaves the first character the scene and finally leaves the second character the scene. The first characters presence may be translated to a first virtual solid body 350 and the second character to a second virtual solid body 350, wherein the both virtual solid bodies 350 are partially overlapping in time.

Another example, is a window on a building representing a first virtual solid body 350 and a person or an object appearing in the window, representing the second virtual solid body 350. In this example may the second virtual solid body 350 at least partially cover the first virtual solid body 350, and thereby partially overlap each other. A number of cases may be illustrating this second example: a person in a car, a character in front of a scenery, a commercial branded object in front of a scenery.

In an embodiment, virtual solid bodies 350 may overlap in a combination of the both above examples. A few illustrative examples: First, a video clip including a sequence of video frames, with an empty car, followed by a person jumping into the car, and driving away. The car may be translated into a first virtual solid body 350, and the person the second virtual solid body 350, and the both virtual solid bodies 350 are overlapping both in time as well as overlapping in terms of partially cover each other. An advantageous benefit of this example may be to be able to find a certain character enter and driving a certain make of car. Another example may be to be able to identify a certain brand or product in context of items like an orange or a celebrity.

In an embodiment a virtual solid body 350 may be extending through a sequence of video frames. Each video frame may be seen as a coordinate system. By determination of coordinates for a first virtual solid body 350, and determination of coordinates for a second virtual solid body 350, it may further be possible to determine a distance between the first virtual solid body 350 and the second virtual solid body 350. A few practical examples may illustrate the benefit of being able to determine a distance between two virtual solid bodies 350: searches for sport games where two particular football players are engaging, searching for occasions where two particular prime ministers are approaching each other, searches in surveillance camera recordings for a victim being approached by a perpetrator, etc. By comparing a first distance D:1 with a second distance D:2, it is possible, by example, to determine if two objects over time appears to get closer to each other, or are moving apart.

When a video frame is seen as a coordinate system, it may be used to determine an area. It may be by describing the boundaries of the area, it may be which pixels that are in the area, or described as a geometrical function.

According to an embodiment, the video frames may be stored in the first database 150. The metadata objects 110 may be stored in the second database 160. Content 100 may, prior reception by the system, has been subject for processing or analyzing. Pre-processes prior to reception, may include face recognition, object recognition, brand recognition, color recognition, audio analysis, speech to text translation, or other type of audio-visual (rich media) analyzing operations. In a non limiting example related to face recognition, face recognition is performed to video frames. For example, when the face is recognized, the area may be determined. If it is the first frame with the face appearing, it may be the first video frame 310, with the primary area 320. However, for each video frame with the face appearing, and potentially the area for the face determined, a metadata object 110 may be associated. The metadata object 110 may contain an identification of the recognized face, e.g. a name, gender, age etc. The metadata object 110 may also contain the area of the face, brand or commercial product both in terms of shape and position in the video frame.

According to an embodiment, sound and other types of non-image based content, in content 100, may be provided or described as virtual solid bodies 350. In a content which provides surround sound, a number of sound sources may be apparent, and providing various sounds or sound sources as virtual solid bodies 350, may be an advantageous way of handling surround sound in content 100. Another example management of other type recorded data, or instructions related to the content. A non limiting example is where movements of the chair are associated with the presentation of a movie. Another example is influence of for example lightening, associated with content.

As shown previously in FIG. 6 the first database 150 has an interface for reception of content 100 and retrieval of content 100. The first database 150 also has an interface for communication with the second database 160. Associations between virtual solid bodies 350 in content 100 and metadata 110 may be performed over the interface between the first and second database 150, 160. At storage of content 100 a conversion may be performed from one format to another format of content 100. Conversion may also be performed at retrieval of content 100 from the first database 150, conversion from one format to another format. Although the first database 150 may handle various formats of content 100, and is therefore not bound by any specified formats.

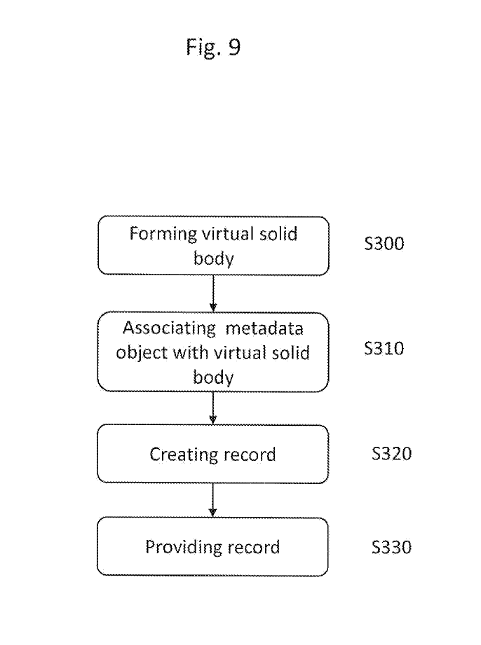

FIG. 9 shows a flowchart illustrating an embodiment of a method for searching in multimedia content 100. In a first step S300 a virtual solid body is formed. The virtual solid body is formed by calculation of a primary area and a secondary area, separated by a function of time, where the calculation forms the virtual solid body. In the next step S310 a metadata object is associated with the virtual solid body. In an embodiment, the metadata object comprises a name of a person, a brand name, e geographical place, or any other graphical object which may be interesting to link to with metadata. In the next step S320, a record is created for the virtual solid body, with the metadata object associated with the virtual solid body included in the record. In the next step S330, the record is provided to a search engine. The record is arranged such that the search engine can perform searches and where a search potentially may result in a pointer to the virtual solid body in the digital content.

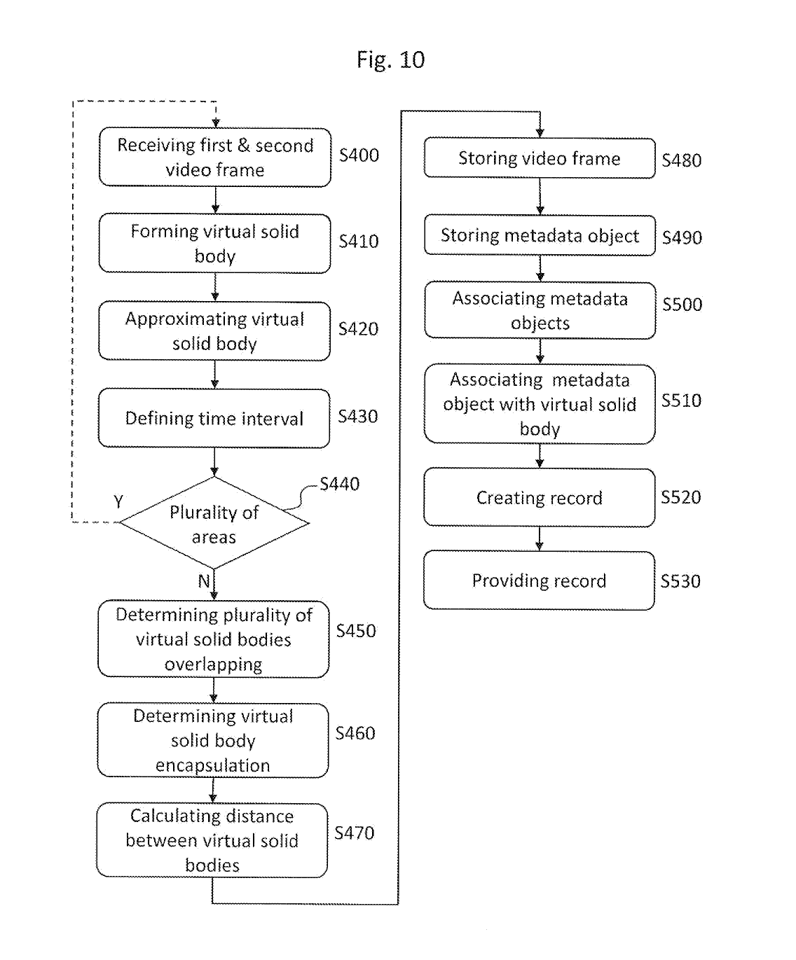

FIG. 10 illustrates a flowchart of embodiments of a method for searches in digital multimedia. In a first step S400 a first video frame with a primary area and a second video frame with a secondary area may be received, with the primary area and secondary area associated with each other. A metadata object may also be received, associated with at least one of the primary or secondary objects. In a next step S410 the virtual solid body may be formed. The virtual solid body may be formed by calculation of a primary area and a secondary area, separated by a function of time, where the calculation forms the virtual solid body.

In a next step S420 the virtual solid body may be formed by approximation. In an embodiment the approximation is performed by use of a rectangular form. In an embodiment the approximation form may be performed by use of parametric curves or NURBS (Non-uniform rational basis spline). In a next step S430, a time for the virtual solid body is defined. The time interval is defined by the first video frame and the second video frame. In an embodiment, with a plurality of video frames in line, the time interval may be defined by the first video frame and the last video frame. In a step S440 it may be determine if there are a plurality of primary areas and/or secondary areas with a particular video frame. If it is determined that there a plurality of areas, the procedure may iterate from start in order to form an at least second virtual solid body. And then further in a next step S450, it may be determined if the plurality of virtual solid bodies are overlapping each other. By determination of if, for example two virtual solid bodies are overlapping, it might be possible to search for a moment where two specific persons are present in a video simultaneously.

In a next step S460, it may be determined if an virtual solid body encapsulates another one. In an embodiment, such encapsulation may be partial. An example is where a person for example is sitting in a cabriolet type of car, where the person is one virtual solid body and the car is the other virtual solid body. In an embodiment, such encapsulation may be full. An example is a person visible inside a house, where the person is one virtual solid body and the house is the other virtual solid body. In a next step S470 a distance between virtual solid bodies may be calculated. An example of that is illustrated in FIG. 8. In an embodiment the distance is calculated by use of a coordinate system.

In a next step S480, the video frames may be stored in a database, for example stored in the first database 150. In an embodiment, a virtual solid body, such as the virtual solid body 350 may be stored in the database. The virtual solid body may be stored as the rectangular approximation, or stored as described by parametric curves or NURBS. The virtual solid body may be stored in other suitable formats, for storage of a virtual solid body in a database. In a next step S490 may a metadata object, associated with a video frame, be stored in a database, for example stored in the second database 160. In a next step S500 metadata objects may be stored with each other. In the next step S510 a metadata object may be associated with the virtual solid body. In the next step S520, a record may be created for the virtual solid body, with the metadata object associated with the virtual solid body included in the record. In the next step S530, the record may be provided to a search engine. The record may be arranged such that the search engine can perform searches and where a search potentially may result in a pointer to the virtual solid body in the digital content.

While the solution has been described with reference to specific exemplary embodiments, the description is generally only intended to illustrate the inventive concept and should not be taken as limiting the scope of the solution. For example, the terms “content”, “video frame”, data base” and “virtual solid body” have been used throughout this description, although any other corresponding terms, nodes, functions, and/or parameters could also be used having the features and characteristics described here. The solution is defined by the appended claims.

1. A method for supporting searching in digital multimedia content (100), the method comprising:
forming a virtual solid body (350) by calculation of a primary area and a secondary area, separated by a function of time, wherein the calculation forms the virtual solid body (350),
associating a metadata object (110) with the virtual solid body (350),
creating a record (130) for the virtual solid body (350), the record (130) containing the metadata object (110) associated with the virtual solid body (350);
providing the record (130) to a search engine (140);
wherein the record (130) is arranged such that searches can be performed by the search engine (140), potentially resulting in a pointer (145) to the virtual solid body (350) in the content (100).

2. The method according to claim 1, comprising:
receiving a first video frame (310) with the primary area (320) and a second video frame (330) with the secondary area (340), the primary area (320) and secondary area (340) being associated with each other,
receiving at least one metadata object (110) associated with at least one of the areas (320:340).

3. The method according to claim 1, wherein
the virtual solid body (350) is calculated by use of parametric curves or NURBS.

4. The method according to claim 1, wherein
the virtual solid body (350) is approximated to a rectangular shaped form.

5. The method according to claim 1, wherein
a video frame (320:n) is a three dimensional projection of a scene.

6. The method according to claim 1, wherein
a virtual solid body (350) is defined by a time interval (120) determined by the first video frame (310) and the second video frame (330).

7. The method according to claim 1, wherein
the first video frame (320:n) contains a plurality of primary areas (320) and/or secondary areas (340).

8. The method according to claim 1, wherein
the plurality of primary areas (320) and or secondary areas (340) forms a plurality of virtual solid bodies (350), wherein
the virtual solid bodies (350) are at least partially overlapping each other.

9. The method according to claim 1, wherein
one virtual solid body (350) at least partially encapsulate another virtual solid body (350).

10. The method according to claim 1, wherein
a relation between two virtual solid bodies (350) is determined by calculation of a distance (D) between a first virtual solid body (350:1) and a second virtual solid body (350:2), when the bodies extends through a video frame (320:n), wherein
the video frame (320:n) is represented by a coordinate system (370), and thus is the distance (D) between the bodies calculable by each body being associated with respective coordinates.

11. The method according to claim 1, wherein the method comprises:
storing of the video frame (320:n) in a first database (150).

12. The method according to claim 1, wherein the method comprises:
storing of the metadata object (110) in a second database (160).

13. The method according to claim 1, wherein the method comprises:
associating at least one metadata object (110), independently, with another metadata object (110).

14. A system for supporting searches in digital multimedia content (100), the system comprising:
means for forming of a virtual solid body (350) by calculation of a primary area and a secondary area, separated by a function of time, wherein the calculation forms the virtual solid body (350),
means for association of a metadata object (110) with the virtual solid body (350),
means for creation of a record (130) for the virtual solid body (350), the record (130) containing the metadata object (110) associated with the virtual solid body (350);
means for provision of the record (130) to a search engine (140);
wherein the record (130) is arranged such that searches can be performed by the search engine (140), potentially resulting in a pointer (145) to the virtual solid body (350) in the content (100).

15. The system according to claim 14, comprising:
means for reception of a first video frame (310) with the primary area (320) and a second video frame (330) with the secondary area (340), the primary area (320) and secondary area (340) being associated with each other,
means for reception of at least one metadata object (110) associated with at least one of the areas (320:340).

16. The system according to claim 14, wherein
the virtual solid body (350) is calculated by use of parametric curves or NURBS.

17. The system according to claim 14, wherein
the virtual solid body (350) is approximated to a rectangular shaped form.

18. The system according to claim 14, wherein
a video frame (320:n) is a three dimensional projection of a scene.

19. The system according to claim 14, wherein
a virtual solid body (350) is defined by a time interval (120) determined by the first video frame (310) and the second video frame (330).

20. The system according to claim 14, wherein
the first video frame (320:n) contains a plurality of primary areas (320) and/or secondary areas (340).

21. The system according to claim 14, wherein
the plurality of primary areas (320) and or secondary areas (340) forms a plurality of virtual solid bodies (350), wherein
the virtual solid bodies (350) are at least partially overlapping each other.

22. The system according to claim 14, wherein
one virtual solid body (350) at least partially encapsulate another virtual solid body (350).

23. The system according to claim 14, wherein
a relation between two virtual solid bodies (350) is determined by calculation of a distance (D) between a first virtual solid body (350:1) and a second virtual solid body (350:2), when the bodies extends through a video frame (320:n), wherein
the video frame (320:n) is represented by a coordinate system (370), and thus is the distance (D) between the bodies calculable by each body being associated with respective coordinates.

24. The system according to claim 14, wherein the method comprises:
means for storage of the video frame (320:n) in a first database (150).

25. The system according to claim 14, wherein the method comprises:
means for storage of the metadata object (110) in a second database (160).

26. The system according to claim 14, wherein the method comprises:
means for association of at least one metadata object (110), independently, with another metadata object (110).

27. A computer program, comprising computer readable code means, which when run in a system for searches of digital multimedia content according to claim 14 causes the system for searches of digital multimedia content to perform the corresponding method according to claim 1.

28. A computer program product, comprising a computer readable medium and a computer program according to claim 27, wherein the computer program is stored on the computer readable medium.
